(19) United States
(12) Patent Application Publication
(10) Pub. No.: US 2016/0281454 A1
(43) Pub. Date: Sep. 29, 2016

(54) CONTROLLED DEGRADATION OF ELASTOMERS AND USE IN OILFIELD APPLICATIONS

(71) Applicant: SCHLUMBERGER TECHNOLOGY CORPORATION, Sugar Land, TX (US)

(72) Inventors: Shitong S. Zhu, Waban, MA (US); Agathe Robisson, Cambridge, MA (US); Francois Auzerais, Boston, MA (US); Meng Qu, Dorchester, MA (US); Miranda Amarante, Somerville, MA (US); Cody Diaz, Humble, TX (US); Matthew Godfrey, Sugar Land, TX (US); Jahir Pabon, Newton, MA (US)

(21) Appl. No.: 14/665,727

(22) Filed: Mar. 23, 2015

(51) Int. Cl. E21B 33/12; C09K 8/508; E21B 33/134

(52) U.S. Cl. CPC E21B 33/12; E21B 33/134; C09K 8/5086

(57) ABSTRACT

Embodiments may include methods that include emplacing a degradable material into a wellbore, wherein the degradable material includes a thermoplastic elastomer; contacting the degradable material with an aqueous fluid downhole; and allowing the degradable material to at least partially degrade. In another aspect, methods may include emplacing into a wellbore a tool containing a sealing element thereon, wherein the sealing element contains a degradable material; engaging the sealing element with a downhole surface to establish a seal; contacting the sealing element with an aqueous fluid; and allowing the sealing element to at least partially degrade, thereby disrupting the established seal.

### BACKGROUND

Natural resources such as gas, oil, and water residing in a subterranean formation or zone may be recovered by drilling a wellbore into a subterranean formation while circulating various wellbore fluids. During subsequent wellbore operations, numerous tools and fluids may be emplaced within the wellbore to perform a variety of functions. For example, wellbore tools such as frac plugs, bridge plugs, and packers may be used to isolate one pressure zone of the formation from another by creating a seal against emplaced casing or along the wellbore wall.

Once the wellbore is completed, production tubing and/or screens may be emplaced within one or more intervals of the formation prior to hydrocarbon production. During production operations, sand control methods and/or devices are used to prevent sand particles in the formation from entering and plugging the production screens and tubes in order to extend the life of the well.

Tools utilized in all stages of wellbore operations may be constructed from various materials suited for activities at temperatures and pressures encountered in downhole environments. Further, downhole tools may also be outfitted with specialty parts made from performance materials that are the same or different from the remainder of the tool body such as seals, chevron seals, o-rings, packer elements, gaskets, and movable parts such as slips, sleeves, and drop balls.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, the present disclosure is directed to methods that include emplacing a degradable material into a wellbore, wherein the degradable material contains a thermoplastic elastomer; contacting the degradable material with an aqueous fluid downhole; and allowing the degradable material to at least partially degrade.

In another aspect, the present disclosure is directed to methods that include emplacing into a wellbore a tool containing a sealing element thereon, wherein the sealing element contains a degradable material; engaging the sealing element with a downhole surface to establish a seal; contacting the sealing element with an aqueous fluid; and allowing the sealing element to at least partially degrade, thereby disrupting the established seal.

Other aspects and advantages of the invention will be apparent from the following description and the appended claims.

### BRIEF DESCRIPTION OF DRAWINGS

The subject disclosure is further described in the detailed description which follows, in reference to the noted plurality of drawings by way of non-limiting examples of the subject disclosure, in which like reference numerals represent similar parts throughout the several views of the drawings.

FIG. 1 is a diagram depicting a degradable ball sealer on a seat within a wellbore tool in accordance with embodiments of the present disclosure;

FIG. 2 is a diagram depicting a pre-perforated pipe plugged with degradable materials in accordance with embodiments of the present disclosure;

FIGS. 3.1-3.3 are various illustrations depicting a wellbore tool having degradable elastomer components in accordance with embodiments of the present disclosure;

FIGS. 4.1-4.2 are schematic representations of polymeric blends in accordance with embodiments of the present disclosure;

FIG. 5 illustrates the macromolecular arrangement of a polymer and rubber blend in accordance with embodiments of the preset disclosure;

FIG. 6 illustrates the macromolecular arrangement of a polymer and plastic blend in accordance with embodiments of the preset disclosure;

FIG. 7 is a plot showing tensile strength as a function of degradation time for degradable elastomers in accordance with embodiments of the present disclosure;

FIG. 8 is a plot showing maximum tensile strain percent as a function of degradation time for degradable elastomers in accordance with embodiments of the present disclosure;

FIG. 9 is a plot showing the change in percent crystallinity (χ_{C}) as a function of time for degradable elastomers in accordance with embodiments of the present disclosure;

FIG. 10 is a plot showing the change in modulus (F) as a function of time for degradable elastomers in accordance with embodiments of the present disclosure;

FIG. 11 is a plot showing storage modulus as a function of time for degradable elastomers in accordance with embodiments of the present disclosure;

FIG. 12 is a plot showing storage modulus as a function of crystalline volume fraction for degradable elastomers in accordance with embodiments of the present disclosure;

FIG. 13 is a plot of the rates of degradation at 120 and 150° C. detected by titration of the acid end groups generated during hydrolysis; and

FIG. 14 is a plot showing a decrease in modulus of samples in accordance with the present disclosure after aging in water at elevated temperature.

### DETAILED DESCRIPTION

The particulars shown herein are by way of example and for purposes of illustrative discussion of the examples of the subject disclosure only and are presented in the cause of providing what is believed to be the most useful and readily understood description of the principles and conceptual aspects of the subject disclosure. In this regard, no attempt is made to show structural details in more detail than is necessary, the description taken with the drawings making apparent to those skilled in the art how the several forms of the subject disclosure may be embodied in practice. Furthermore, like reference numbers and designations in the various drawings indicate like elements.

Embodiments of the present disclosure are directed to degradable materials that may undergo changes in various properties upon interaction with triggering stimuli such as mechanical or physical changes, or chemical reactions that induce degradation of the material. In one or more embodiments, degradable materials may provide acceptable performance for a certain period of time and then degrade over time when exposed to a downhole environment, or may be triggered to degrade upon exposure to one or more selected stimuli. The term “degradation” as used herein refers to any process that converts at least a portion of a degradable material from a first physical state to a second physical state. For example, degradation may be in the form of dissolution, disintegration, fragmentation, deformation, distortion, swelling, or shrinkage.

In one or more embodiments, degradation of the degradable materials may be initiated by contact with selected fluids, or by changes in temperatures and/or pressure. Further, the pH of the fluids contacting the degradable material may also be changed to adjust the rate of degradation. For degradable materials used in downhole environments, triggering stimuli may be either present downhole or introduced prior, during, and/or after placement into a wellbore.

Degradable materials in accordance with embodiments of this disclosure may be a homogenous polymer or formulated as a blend or composite, and may be used in the manufacture of downhole tools, mechanical devices, and components thereof, to divert wellbore fluids to a targeted zone within a formation. In one or more embodiments, downhole tools may include ball sealers, packers, straddle-packer assemblies, bridge plugs, frac plugs, darts, drop balls, seats, and loading tubes for perforating guns. Further, degradable materials may find utility as materials for zonal isolation, bridging, plugging, or reducing fluid loss.

When incorporated into tools and other downhole materials, degradable materials in accordance with the present disclosure may exhibit a number of beneficial physical properties that may include favorable wear resistance, and improved resistance to cut growth, deformation, and extrusion when compared to conventional rubbers. In one or more embodiments, mechanical and other performance properties of degradable materials of the present disclosure may be controlled by tuning the rate of hydrolytic degradation of constituent polymers in aqueous fluids.

In one or more embodiments, degradable materials may be incorporated in a wellbore tool as a degradable ball sealer or as a degradable ball seat. As known in the art, ball sealers are small spheres designed to seal perforations, or ball seats, within a wellbore tool, thereby diverting pumped fluids into other regions of the wellbore tool and/or into a surrounding subterranean formation. In some embodiments, ball sealers may be incorporated into a wellbore fluid and pumped through a wellbore tool. The effectiveness of this type of mechanical diversion to keep the balls in place is dependent on the differential pressure across a ball seat and the geometry of the ball seat.

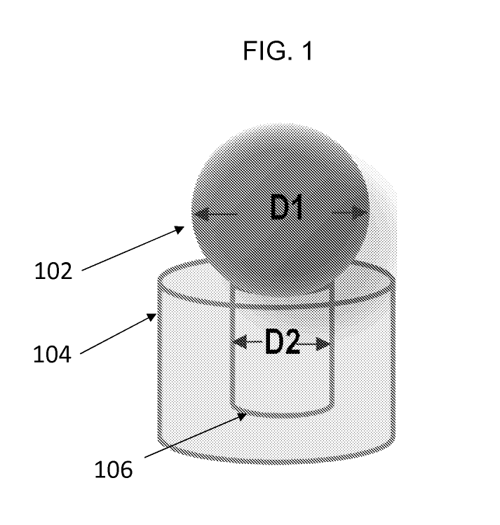

With particular respect to FIG. 1, an example of a ball sealer 102 installed on a ball seat 104 is shown. The ball sealer 102 is sized having a diameter D1 that exceeds the diameter D2 of an interior conduit 106 of the ball seat. The ball sealer may be made from a rigid material and/or sized such that it resists extrusion through the conduit diameter D2 in some embodiments, while in other embodiments ball sealers may be sized such that it remains seated within a given range and extrudes through the conduit diameter once the differential pressure exceeds a predetermined threshold. In some embodiments, the ratio of the diameters D1 and D2 may be selected depending on the expected differential pressure within a wellbore tool, which may reach or exceed 10,000 psi in some embodiments.

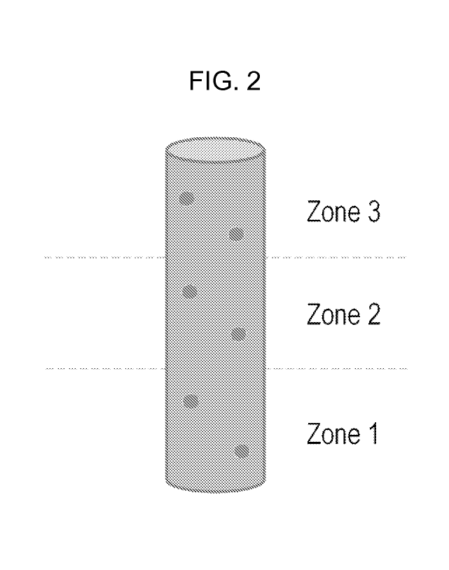

In one or more embodiments, degradable materials may be included as a plug installed in pre-perforated pipes. With particular respect to FIG. 2, an embodiment of the present disclosure is illustrated in which degradable materials are used in the pre-perforated pipe. In some embodiments, pre-perforated pipes may include differing types of degradable materials, having unique rates of degradation such that intervals of a wellbore in which the tool is emplaced may be treated sequentially as the degradable materials are displaced and injected fluids are perfused through the perforations in the tool. For example, perforated piping containing multiple zones of degradable material may be used by contacting a first zone with the appropriate stimulus to initiate degradation, treating the freshly exposed formation, and then applying the appropriate degradation stimulus to the next zone in sequence. While FIG. 2 shows an embodiment containing three zones for treatment, it is envisioned that more or less zones may be used, depending on the requirements of a given application.

In one or more embodiments, degradable materials may be used as a component of a wellbore tool. In some embodiments, wellbore tools may include completion tools such as packers, which may be deployed to predetermined locations within a wellbore to provide basic functions, such as zonal isolation, tubing anchoring, casing protection, and flow control. Packers may include production packers, zonal isolation packers, gravel pack packers, and the like. In some embodiments, packers are surface controlled and set by mechanical and/or hydraulic mechanisms.

In one or more embodiments, wellbore tools may contain one or more sealing elements that are capable of engaging a surface downhole to form a seal. In some embodiments the tool may be formed from a degradable material, or the sealing elements may contain at least a fraction of degradable material. Wellbore tools in accordance with embodiments of the present disclosure may be operated by techniques known in the art including, for example, mechanical action or by hydraulic pressure. Wellbore tools in accordance with some embodiments of the present disclosure may enable removal of the tool after wellbore operations have been completed by contacting the degradable tool with the appropriate stimulus, such as an aqueous fluid, acid, base, increase in temperature, etc. Following initiation of degradation of the wellbore tool, the seal created may be disrupted as the mechanical properties of the tool begin to change, which may disrupt the seal and allow for removal and/or initiation of fluid or gas flow in some embodiments.

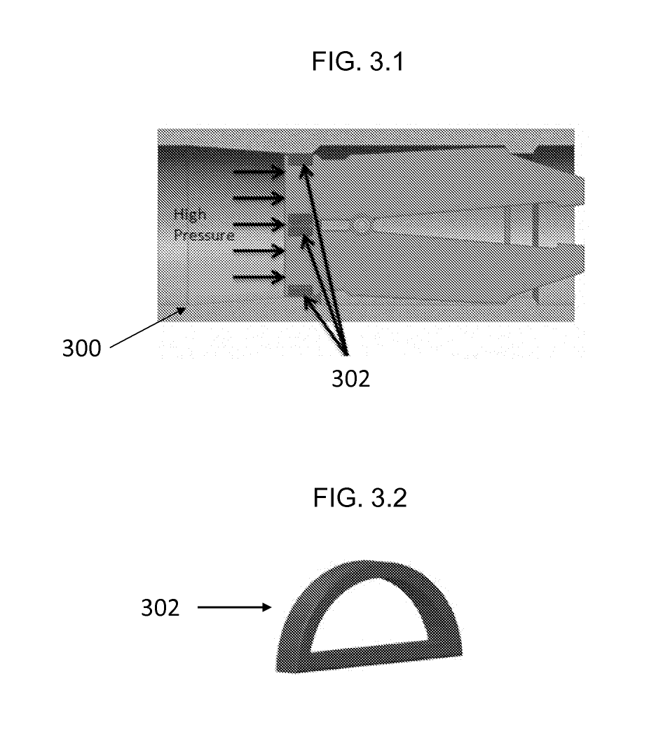

In some embodiments, degradable materials may be used to construct sealing elements on a wellbore tool that form a seal between the tool and a casing or formation that resists or stops the flow of fluids and/or gases from one or more intervals in a borehole. With particular reference to FIG. 3.1, a pivot dart wellbore tool 300 is shown in which a degradable material is used to construct sealing elements 302 that stabilize the tool in a set interval of the wellbore, even in the presence of elevated pressures downhole. In one or more embodiments, pivot dart tools may include those available from Schlumberger Technology Corporation such as those described in U.S. Patent Pub. 2014/0299319, which is incorporated herein by reference in its entirety. In some embodiments, as illustrated in FIG. 3.2, sealing elements constructed out of a degradable elastomer may be hollow body elements that allows for some degree of pliability when a wellbore tool is installed.

With particular reference to FIG. 3.3, a sealing element 302 may engage an external surface 304 creating a seal having a corresponding extrusion gap 306 that withstands pressure differentials created by high pressure (P_{H}) and low pressure (P_{L}) intervals. Degradable materials may be used to prepare degradable sealing components that are placed at one or more positions of the circumference of a downhole tool in some embodiments, or used to form components that seal around the circumference of a perimeter of a tool such as an o-ring. In some embodiments, sealing components may include a degradable material that swells in the presence of suitable stimuli such as exposure to an aqueous or oil-based fluid.

In one or more embodiment, degradable materials may have resistance to extrusion when used in sealing applications. For example, when employed as mechanically expandable bridge plugs, the plug may be emplaced through relatively small production pipes and then expanded under hydraulic pressure to plug an interval of the wellbore. In some embodiments, degradable materials may be incorporated into open-hole packers as a replacement for or in combination with non-extrudable rubbers or elastomers, including non-degradable materials such as thermoplastic vulcanizates (e.g., polyolefin-EPDM blends) and copolymers such as styrene block copolymer (SBS).

In one or more embodiments, degradable materials may be used as one or more components of an inflatable packer. Inflatable packers may include an inflatable bladder to expand the packer element against the casing or wellbore to provide zone isolation. In preparation for setting the packer, a drop ball or series of tubing movements are generally required, with the hydraulic pressure required to inflate the packer provided by carefully applying surface pump pressure. Inflatable packers are capable of relatively large expansion ratios, an important factor in through-tubing work where the tubing size or completion components can impose a size restriction on devices designed to set in the casing or liner below the tubing.

In some embodiments, degradable materials may be incorporated into swellable packers. Swellable packers in accordance with embodiments disclosed herein include packers used with or without additional mechanical or hydraulic setting mechanisms. Swellable packers may include a swellable material that increase in volume upon contact with a water- or oil-based fluid depending on the selected swellable material. Depending upon the types of fluids and swellable materials used, the swelling process may increase the volume of a packer by as much as several hundred percent.

In some embodiments, degradable materials may be used to make wear-resistant, protective pockets or encapsulation for electronics, devices, and sensors. For example, degradable materials may encapsulate a device or sensor downhole, and then degrade upon experiencing a suitable stimuli downhole, exposing the encapsulated device or sensor, and allowing operation.

### Degradable Materials

Degradable materials in accordance with the present disclosure may include polymers, copolymers, and higher order polymers (such as terpolymers and quaternary polymers), and blends of various types of polymers. In one or more embodiments, polymer systems may exhibit primarily crystalline or amorphous character, and exhibit either melt or glass transition behavior respectively.

Due to relatively strong intermolecular forces, crystalline and semicrystalline polymers resist softening and the elastic modulus for these materials normally changes at temperatures above the melting temperature (Tm). Amorphous polymers on the other hand, undergo a reversible transition that when exposed to increasing temperature referred to as a “glass transition.” Similarly, “glass transition range” describes the temperature range in which the viscous component of an amorphous phase within a polymer increases and the observable physical and mechanical properties undergo a change as the amorphous phase begins to enter a molten or rubber-like state. Below the glass transition range characteristic to a given polymer, the amorphous phase of a polymer is in a glassy state that is hard and fragile. However, under an external force, amorphous polymers may still undergo reversible or elastic deformation and permanent or viscous deformation. Another useful metric is the glass transition temperature (Tg) in which the slope of the curve of the specific volume as a function of temperature for the material increases during the transition from a glass to liquid.

In one or more embodiments, degradable materials may include block copolymers, which may contain both crystalline and amorphous domains. Because most polymers are incompatible with one another, block polymers may “microphase separate” to form periodic structures in which one fraction of the polymer remains amorphous, allowing polymer chains to mix and entangle, while a second fraction may interlock to form crystalline structures.

In one or more embodiments, the degradable materials may be, or include as a fraction thereof, a thermoplastic elastomer (TPE). TPE in accordance with embodiments disclosed herein includes copolymers (and higher order polymers) or physical mixes of polymers (such as mixtures of plastics and rubbers) that create materials having both thermoplastic and elastomeric properties. When compared to thermoset elastomers, for example, thermoplastics may be adapted more easily for manufacturing methods such as injection molding. In some embodiments, TPEs may exhibit properties of both a rubber and a plastic. While not limited by a particular theory, it is believed that the difference between thermoset elastomers and thermoplastic elastomers may be explained in part by the type of crosslinking between polymer chains in their respective structures. For example, crosslinking may impart a degree of elasticity to the material properties of a given polymeric material.

In one or more embodiments, degradable materials may include polymeric materials such as thermoplastic elastomer (TPE). In some embodiments, TPEs may be multi-block copolymers that form polymeric networks having one or more phases ranging from relatively dense crystalline or microcrystalline phases to more compliant amorphous phases. Polymeric networks created by TPE may arise from physical crosslinks through the interaction of the crystalline phases or hydrogen bonding, providing a degree of elasticity at temperatures below the melting point of the polymer. Physical crosslinking is thermoreversible, and TPE polymers in some embodiments may be processed using conventional melt-process facilities such as injection molding, extrusion, BMC, etc.

In some embodiments, TPEs may have crystalline domains capable of co-crystallizing with domains on adjacent polymer chains, such as is observed in copolyester rubbers, resulting in a material having similar physical properties to materials constructed from rubbers such as SBS block polymers. Depending on the block length of their constituent crystalline phases, the temperature stability of a given degradable material may increase due to the higher relative crystal melting point. In some embodiments, crystal melting temperature may be a measure of the processing temperatures needed to shape a particular polymeric material, in addition to being an important consideration of ultimate service use temperatures of the product.

In one or more embodiments, degradable materials may include TPEs such as polyester amides (PEA); polyetheresteramide (PEEA); polycarbonateesteramides (PCEA); polyether-block-amides such as those prepared from polyamide 6, polyamide 11, or polyamide 12 copolymerized with an alcohol terminated polyether; polyphthalamide; copolyester elastomers (COPE); thermoplastic polyurethane elastomers prepared from polyols of poly(ethylene adipate) glycol, poly(butylene-1,4 adipate) glycol, poly(ethylene butylene-1,4 adipate) glycol, poly(hexamethylene-2,2-dimethylpropylene adipate) glycol, polycaprolactone glycol, poly(diethylene glycol adipate) glycol, poly(hexadiol-1,6 carbonate) diol, poly(oxytetramethylene) glycol); and blends of these polymers. Other examples of commercially available polymer products suitable for use as a degradable material include Hytrel® polymers (DuPont®), Vestamid® E (Evonik), Texin®, Desmoflex®, Desmovit®, Desmosint® (Bayer), Carbothane™ TPU, Isoplast® ETPU, Pellethane® TPU, Tecoflex™ TPU, Tecophilic™ TPU, Tecoplast™ TPU, Tecothane™ TPU (Lubrizol), Rilsan® HT, Arnitel® (DSM®), Solprene® (Dynasol®), Engage® (Dow Chemical®), Dryflex® and Mediprene® (ELASTO®), Kraton® (Kraton Polymers®), Pibiflex®, Forprene®, Sofprene®, Pebax®, and Laprene®. In other possible embodiments, degradable materials may be mixed with other polymers such as rubbers, thermoplastics, or fillers to form composites and blends.

### Controlling Degradation Rates of Degradable Materials

The rate of degradation of degradable materials in accordance with embodiments of the present disclosure may be affected by a number of factors including temperature, pressure, and concentration of water in a medium surrounding the degradable material. In embodiments directed to uses in downhole environments, the type of polymer may be varied to account for the average expected or measured temperature downhole. For example, downhole temperatures may vary over a wide range and based on the range determined, degradable materials may be selected prior to or during downhole operations. In one or more embodiments, degradable materials may degrade within a temperature range of about 100° F. (38° C.) to more than 400° F. (205° C.) in some embodiments, from 140° F. (60° C.) and 400° F. (205° C.) in some embodiments, and from 250° F. (120° C.) to 400° F. (205° C.) in some embodiments.

In one or more embodiments, degradation of degradable materials may be enhanced by disrupting the crystalline phase of the constituent polymer. Once the crystalline domains are disrupted, the amorphous phase may lose mechanical rigidity and flow as the temperature increases above the glass transition temperatures (Tg) of the material. Other possible degradation mechanisms include degrading the amorphous domains of the material, which decreases the molecular weight of the polymer chains and physical resilience of the overall material.

In one or more embodiments, degradation of the material may be tuned by increasing or decreasing the number of hydrolyzable bonds in the constituent polymers of the degradable material. Hydrolyzable bonds react with water through nucleophilic displacement, resulting in the formation of a new covalent bond with a hydroxyl (OH) group that displaces the previous bond and produces a leaving group. In some embodiments, deterioration/loss of mechanical strength of a degradable material may be the result of hydrolytic bond cleavage that results in disintegration into shorter chain polymers and monomers. Degradable materials in accordance with the present disclosure may include polymers, copolymers, and higher order polymers having hydrolyzable bonds incorporated in one or more polymer chains. Examples of hydrolyzable bonds include esters, amides, urethanes, anhydrides, carbamates, ureas, and the like.

Hydrolysis of degradable materials in accordance with embodiments of the present disclosure may be initiated by contacting a degradable material with an aqueous fluid. In applications directed to operations within a wellbore, aqueous fluids may be injected prior to or after emplacement of a degradable material, or may be present naturally downhole. Aqueous fluids in accordance with the present disclosure may include at least one of fresh water, sea water, brine, mixtures of water and water-soluble organic compounds, and mixtures thereof. In various embodiments, the aqueous fluid may be a brine, which may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, and lithium salts of chlorides, bromides, carbonates, iodides, chlorates, bromates, formates, nitrates, oxides, sulfates, silicates, phosphates and fluorides. Salts that may be incorporated in a brine include any one or more of those present in natural seawater or any other organic or inorganic dissolved salts.

Other suitable base fluids useful in methods described herein may be oil-in-water emulsions or water-in-oil emulsions in one or more embodiments. Suitable oil-based or oleaginous fluids that may be used to formulate emulsions may include a natural or synthetic oil, and in some embodiments the oleaginous fluid may be selected from the group including diesel oil; mineral oil; a synthetic oil, such as hydrogenated and unhydrogenated olefins including polyalpha olefins, linear and branch olefins and the like, polydiorganosiloxanes, siloxanes, or organosiloxanes, esters of fatty acids, specifically straight chain, branched and cyclical alkyl ethers of fatty acids, mixtures thereof and similar compounds known to one of skill in the art; and mixtures thereof.

The rate of degradation by hydrolysis may be controlled by several methods. In one approach, rates of degradation may be tuned by blending degradable materials with one or more hydrolysis inhibitors that consume produced acids, reducing the effect of acid catalyzed auto-acceleration of hydrolysis of the constituent polymers of the degradable materials. For example, carbodiimides may be incorporated into a degradable material as a competitive inhibitor in some embodiments that slows down polymer hydrolysis by reacting with water to produce a corresponding urea that neutralizes the produced acid.

In another approach, combinations of various types of degradable materials including TPE and other types of polymers may be blended together to tune the rate of hydrolysis. In some embodiments, the rate of hydrolysis of thermoplastic polyurethane (TPU) may follow the order of polyether<polycaprolactone<polyester, with polyester exhibiting a higher relative rate of hydrolysis than the other polymers. For example, a blended polyether and polyester type of TPU will have a slower rate of degradation than a polyester type TPU.

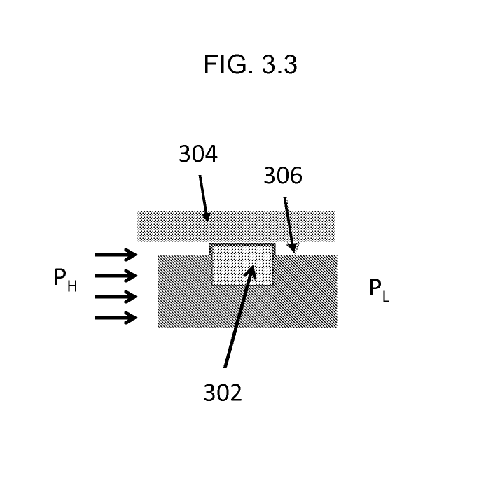

In some embodiments, control over degradation of a degradable material may involve blending TPE with other non-degradable rubbers and polymers to slow water diffusion into the degradable material and decrease the rate of deterioration of mechanical strength. It is envisioned that in some embodiments non-degradable materials may form a coating or a partial coating that decreases the surface area of the degradable material exposed to water or other solvents that initiate degradation. In other embodiments, a tool may be designed such that degradable materials are exposed to the wellbore environment when the tool undergoes a conformational change when emplaced and/or activated. Examples of the non-degradable materials that may be used in accordance with embodiments of the present disclosure include carboxylated acrylonitrile butadiene rubber (XNBR), hydrogenated acrylonitrile butadiene rubber (HNBR), fluoroelastomer, Viton™, EPDM, polybutylene glycol, polytetrafluoroethylene powders (PTFE), and the like. While not bound by a particular theory, when combined with other degradable polymers, non-degradable rubbers may stay in the amorphous phase of a degradable material as shown in FIG. 4.1.

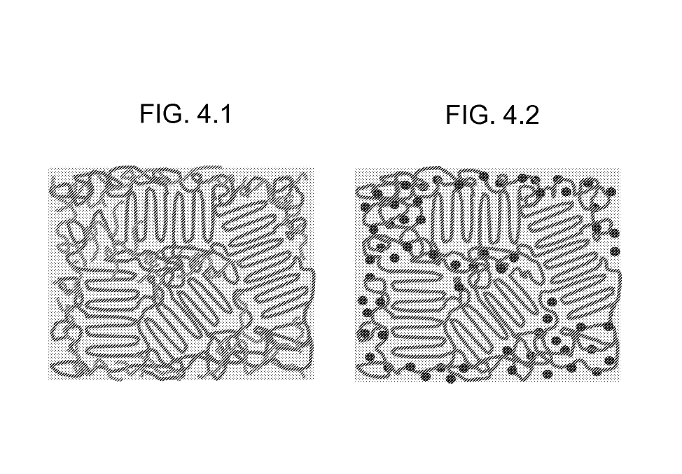

Blending and/or compounding of polymers may be accompanied with vulcanization to form a stronger interphase between TPE and other rubbers or polymers. With particular respect to FIG. 5, an example of a co-continuous blend of a first polymer 502 and a second polymer 504 is shown in which the polymers remain segregated into distinct phases. In embodiments directed to vulcanized degradable materials, suitable catalysts and other additives known in the art, e.g., peroxides, persilicates, persulfates, and azobis compounds that are used routinely in rubber vulcanization could also be used in the compounding of degradable materials such as TPE and other rubbers or polymers.

In one or more embodiments, the rate of degradation of a degradable material may be modified by admixing a TPE with other degradable or water soluble polymers with a continuous, discontinuous, or co-continuous polymer phase. Examples of degradable polymers include aliphatic polyesters, poly(lactic acid) (PLA), poly(ε-caprolactone), poly(glycolic acid) (PGA), poly(lactic-co-glycolic acid), poly(hydroxyl ester ether), poly(hydroxybutyrate), poly(anhydride), polycarbonate, poly(amino acid), poly(ethylene oxide), poly(phosphazene), polyether ester, polyester amide, polyamides, sulfonated polyesters, poly(ethylene adipate), polyhydroxyalkanoate, poly(ethylene terephtalate), poly(butylene terephthalate), poly(trimethylene terephthalate), poly(ethylene naphthalate) and copolymers, blends, derivatives or combination of any of these degradable polymers.

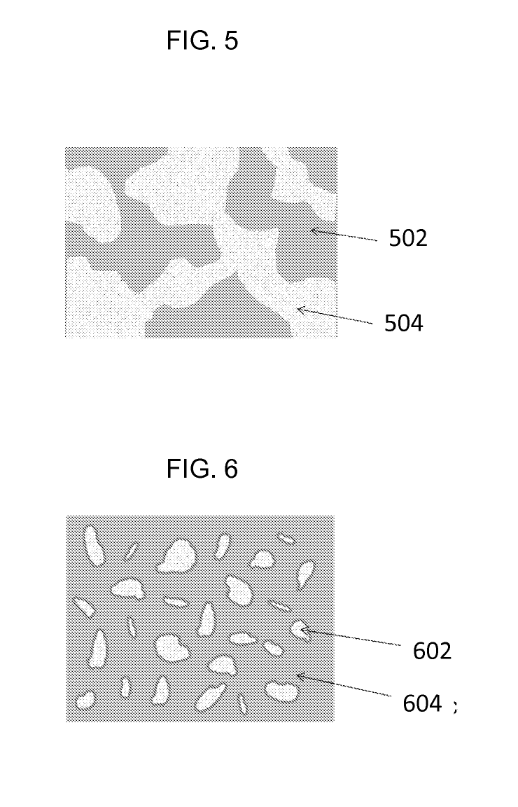

In one or more embodiments, degradable materials that hydrolyze at ultra-low temperatures may be produced by incorporating a TPE into low temperature degradable or soluble thermoplastic polymers using dynamic vulcanization. As shown in FIG. 6, a TPE 602 is dispersed in degradable amorphous polymer 604 such as polylactic acid (PLA), polyglycolic acid (PGA), or polyvinyl alcohol (PVOH). The elasticity of the polymer blend may be derived from a portion of TPE in some embodiments. However, in some embodiments polymers having a higher relative elasticity to TPE may also be combined with TPE and blended into degradable thermoplastics.

In one or more embodiments, the hydrolysis of degradable materials may be accelerated through the addition of pH modifiers or pH modifier precursors. The use of pH modifiers to adjust the degradation of a polymeric material may find utility in some instances where the downhole temperature lies outside of a predetermined temperature range for degradation. For example, degradable materials having ester linkages in the backbone of the constituent polymer may hydrolyze faster when exposed to acidic or basic pH.

Effective compounds for use as pH modifiers in accordance with the present disclosure include acids, bases and precursors thereof. In one or more embodiments, degradable materials may be compounded with a base such as sodium hydroxide, potassium hydroxide, ammonia, and the like; or a base precursor such as Ca(OH)₂, Mg(OH)₂, CaCO₃, MgO, CaO, ZnO, NiO, CuO, Al₂O₃, borax, sodium pentaborate, sodium tetraborate, etc. With particular respect to FIG. 4.2, an embodiment is shown in which a thermoplastic elastomer is blended with magnesium oxide and zinc oxide in order to increase the rate of degradation of the polymer in some applications.

In one or more embodiments, pH modifiers may include acids such as strong mineral acids, such as hydrochloric acid or sulfuric acid, and organic acids, such as citric acid, lactic acid, malic acid, acetic acid, and formic acid. In some embodiments, the pH modifier may be an acid precursor that hydrolyzes to produce an active acid including hydrolyzable esters of a carboxylic acid and an alcohol, including esters of C1 to C6 carboxylic acid and a C1 to C30 alcohol. In some embodiments, the pH modifier may be a Lewis acid, including ZnCl₂, AlCl₃, FeCl₃, AlF₃, etc.

In some embodiments, the hydrolysis of a degradable material may be enhanced by compounding degradable polymers with phase-changing additives that may liquefy when surrounding temperatures exceed the phase transition temperature of the additive. Once phase-changing additives have liquefied, voids and free volume created may increase the accessibility of aqueous fluid into the degradable material. Examples of phase-changing additives may include waxes, such as candelilla wax, carnauba wax, ceresin wax, Japan wax, microcrystalline wax, montan wax, ouricury wax, ozocerite, paraffin wax, glycerol monostearate, silicon wax, rice bran wax, and sugarcane wax. Other suitable waxes include N-(2-hydroxyethyl) 12-hydroxystearamide waxes such as Paricin® 220; Paraffin/oxidized polyethylene/calcium stearate wax blends such as Petrac® waxes, Petrac® 215, and Petrac® GMS; hydrocarbon wax blends such as Fischer-Tropsch wax; and montan waxes commercially available as Ross wax 140, and Ross wax 160.

Degradation times of degradable materials may be modified by any of the approaches described above. Further, it is also within the scope of this disclosure for a degradable material to incorporate one or more of the above described approaches to degradation control. Polymer blends in accordance with the present disclosure may be prepared by any methods known by those of skill in the art, including batch mixing, communition and melting, copolymerization, etc.

### Incorporation of Swellable Materials

In one or more embodiments, degradable materials may incorporate a swellable material that swells in the presence of an aqueous fluid. In embodiments containing a swellable material, degradable materials may find additional utility when used for sealing or fluid loss remediation operations. In one or more embodiments, swellable materials incorporated into a polymer matrix of a degradable material may act as an amorphous phase that absorbs aqueous fluids and/or solvents. In some embodiments, osmotic pressure changes resulting from the solubilization of salts incorporated in a degradable material may also be used to affect swelling in wellbore operations.

In another possible approach, degradable materials may be compounded with water absorbing fillers that facilitate diffusion of aqueous fluids into the material, increasing surface area exposure and increasing the observed degradation rate at a given temperature. Examples of materials useful as water absorbing fillers in accordance with the present disclosure include NaCl, ZnCl₂, CaCl₂, MgCl₂, Na₂CO₃, K₂CO₃, KH₂PO₄, K₂HPO₄, K₃PO₄, sulfonate salts, such as sodium benzenesulfonate, sodium dodecylbenzenesulfonate, water absorbing clays, such as Bentonite, Halloysite, Kaolinite, and Montmorillonite, water soluble/hydrophilic polymers, such as poly(ethylene-co-vinyl alcohol) (EVOH), modified EVOH, amorphous vinyl alcohol resin, super absorbent polymers, polyacrylamide or polyacrylic acid and poly(vinyl alcohols), poly(methacrylic acid), poly(acrylic acid-co-acrylamide), poly(acrylic acid)-graft-poly(ethylene oxide), poly(2-hyroxyethylmethacrylate), starch-grafted polymers, and the mixture of these fillers and derivatives thereof.

Other diffusion enhancing materials may include long chain (defined herein as an alkyl or branched alkyl having ≧8 carbon atoms) fatty acids such as octoates, stearates, palmates, myrisates, and the like may be used as well to facilitate water diffusion and degradation of the TPE. Suitable fatty acids may be provided as a salt having counter ions such as Zn, Sn, Ca, Li, Sr, Co, Ni, K, and the like.

In one or more embodiments, the above described fillers may modify the mechanical properties of a degradable material once incorporated and change the diffusion properties and/or the thermal properties. In some embodiments, fillers may increase the porosity of the material and facilitate fast water diffusion into the degradable materials and increase the rate of hydrolysis.

In one or more embodiments, degradable materials may incorporate swellable elastomeric compositions which may be selected from natural rubber and any substance emulating natural rubber. Swellable elastomers include blends (physical mixtures) of elastomers, as well as copolymers, terpolymers, and multi-polymers. Examples include ethylene-propylene-diene polymer (EPDM), various nitrile rubbers which are copolymers of butadiene and acrylonitrile such as Buna-N (also known as standard nitrile and NBR). By varying the acrylonitrile content, elastomers with improved oil/fuel swell or with improved low-temperature performance can be achieved. Specialty versions of carboxylated high-acrylonitrile butadiene copolymers (XNBR) provide improved abrasion resistance, and hydrogenated versions of these copolymers (HNBR) provide improved chemical and ozone resistance elastomers. Carboxylated HNBR is also known. In certain embodiments, the swellable elastomer may be the reaction product of a linear or branched polymer having residual ethylenic unsaturation with an ethylenically unsaturated organic monomer having at least one reactive moiety selected from acid, acid anhydride, and acid salt. Other useful swellable elastomers are discussed herein.

In one or more embodiments, the swelling agent may be a mineral filler capable of swelling on contact with water. In some embodiments, swelling agents may include alkali earth metal carbonates and alkaline earth carbonates, such as sodium carbonate and soda ash; metal oxides such as magnesium oxide, calcium oxide, magnesium oxide, nickel oxide zincite, beryllium oxide, copper oxide; and the like. Swelling agents may be either magnesium oxide (MgO) or calcium oxide (CaO) used alone or together in some embodiments.

In other embodiments, swelling materials may include cements, including hydraulic cements that cure or harden when exposed to aqueous conditions. Cements in accordance with the present disclosure may include hydraulic cements known in the art, such as those containing compounds of calcium, aluminum, silicon, oxygen and/or sulfur, which set and harden by reaction with water. Suitable cements include “Portland cements,” such as normal Portland or rapid-hardening Portland cement, sulfate-resisting cement, and other modified Portland cements; high-alumina cements, high-alumina calcium-aluminate cements, Sorel cements such as those prepared from combinations of magnesia (MgO) and magnesium chloride (MgCl₂); and the same cements further containing small quantities of accelerators or retarders or air-entraining agents.

### Control Over Strength and Modulus of Degradable Materials

In one or more embodiments, the strength of degradable materials may be controlled by the addition of one or more reinforcing fillers to increase, for example, modulus, strength, or elongation. Degradable materials may include a number of other additives, such as fillers, plasticizers, accelerants, fibers, rubber particles, nanoflakes and/or nanoplatelets and the like, depending on the application conditions, that alter the mechanical toughness of the degradable material.

In copolymer and polymer blends in accordance with the present disclosure, the blend microstructure may also influence the mechanical properties of the final material. Degradable materials in accordance with the present disclosure may be blended in some embodiments with other polymers such as polybutylene glycol to reduce the modulus.

Another approach to increasing the permeability of aqueous fluids into degradable materials may include blending degradable materials with non-reactive fillers like carbon black and silica as reinforcing fillers, or non-reinforcing fillers such as calcium carbonate, clay, talc, dolomite, mica, montmorillonite, barite, calcium sulfate products, wollastonite, phyllosilicates, degradable particulate fillers such as polylactic acid, and other swellable fillers such as hydrogel particles.

In some embodiments, the surface of selected fillers may be modified chemically. For example, if it is desired that the hydrophilicity or hydrophobicity of the particle be tuned to improve their dispersion and interaction with the polymer matrix, small molecules or polymers may be grafted on the surface of the non-reactive filler. In one or more embodiments, surface treatment of fillers may include reacting fillers with organosilanes, modified oligomers, polymers containing anhydride functional groups, and/or a wide variety of surfactants.

Further, suitable fillers in accordance with embodiments disclosed herein may vary in shape, e.g., spherical, colloidal, rods, fibers, or any other shape, or be a mixture of shapes. In one or more embodiments, the fillers described above may be selected from a wide range of sizes, molecular weights, and suppliers. In some embodiments, fillers may possess a length (or diameter for spherical or approximately spherical particles) having a lower limit equal to or greater than 10 nm, 100 nm, 500 nm, 1 μm, 5 μm, 10 μm, 100 μm, 500 μm, and 1 mm, to an upper limit of 10 μm, 50 μm, 100 μm, 500 μm, 800 μm, 1 mm, and 10 mm, where the length (or diameter for spherical or approximately spherical particles) of the filler may range from any lower limit to any upper limit.

The surface area of fillers in accordance with embodiments may be in the range of 10 m²/g to 200 m²/g in some embodiments, from 50 m²/g to 150 m²/g in other embodiments, and greater than 150 m²/g in yet other embodiments.

### EXAMPLES

In the following examples, embodiments of degradable materials in accordance with the present disclosure are demonstrated, but are not meant to limit the scope of this disclosure in any manner.

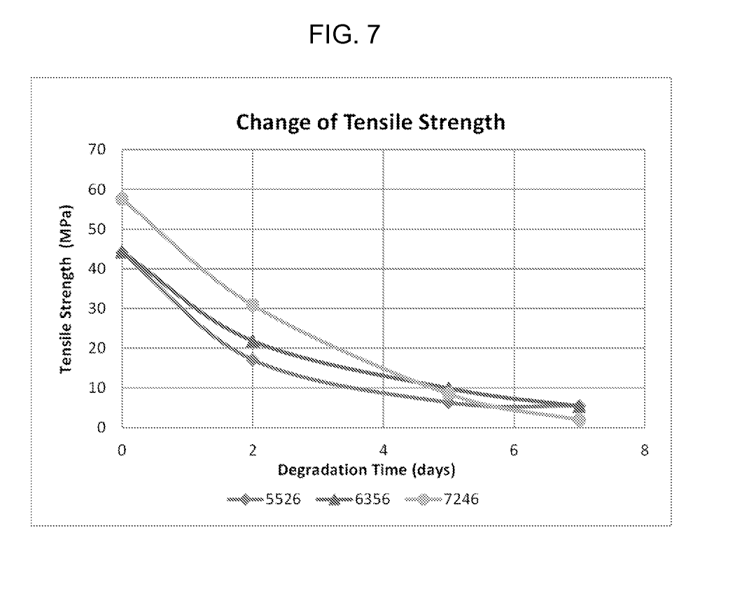

In a first example, the tensile strength of three elastomers was assayed when exposed to water at elevated temperatures. The three polymers studied were copolyester-based TPEs Hytrel® 5526, 6356, and 7246, commercially available from DuPont. The samples were submerged in water at 248° F. (120° C.) to initiate the degradation process. The elastomer samples lost their tensile strength after hydrolysis in water and at simulated downhole conditions of 248° F. (120° C.) for 7 days (under pressure). The elasticity was also lost after two days at the same condition. As shown in FIG. 7, three samples of TPE exposed to simulated wellbore conditions exhibited decreases in tensile strength (MPa) as a function of time (days).

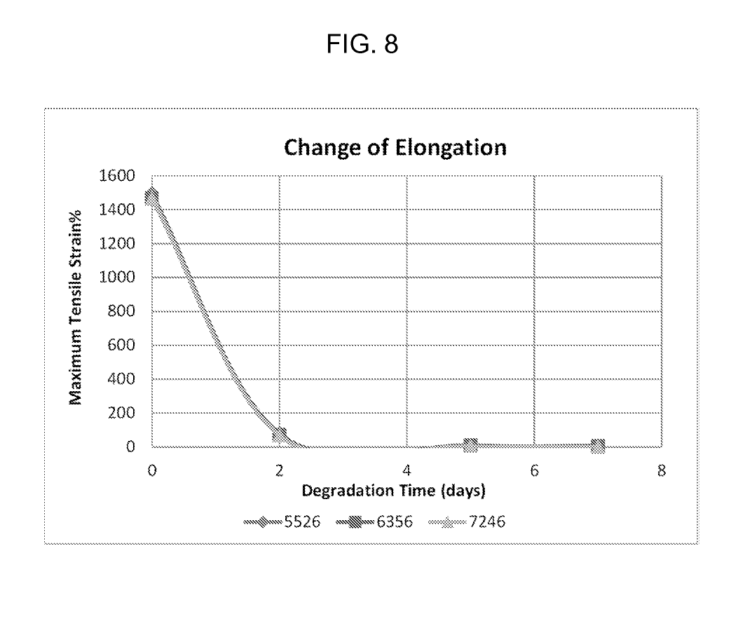

The change in elongation of the three TPEs was also studied as the materials degraded. With particular respect to FIG. 8, the maximum tensile strain for the samples was measured as a function of degradation time (days). Similar to the results in FIG. 7, the mechanical properties for the materials reached a minimum at approximately two days.

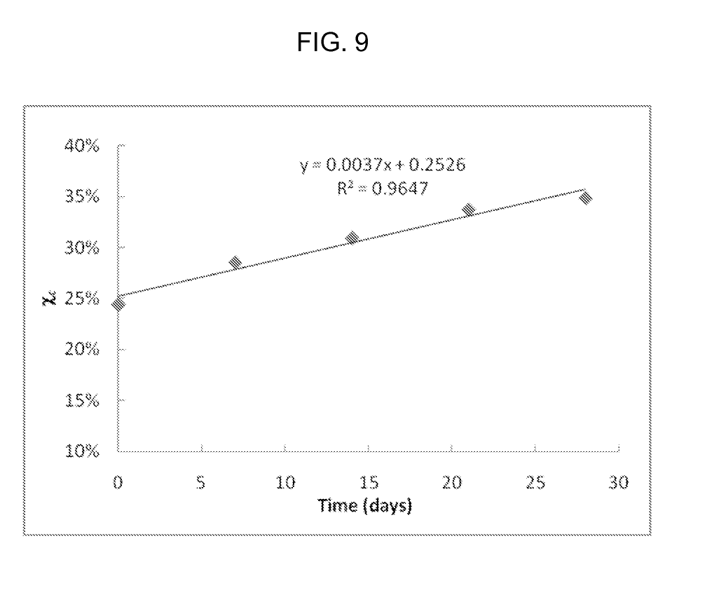

In another example, morphology changes of the degradable material Hytrel® 7246 were measured in the crystalline and amorphous domains of the material. Degradation of a sample in water at 208° F. (98° C.) was studied by monitoring the melting enthalpy of the material using DSC at a scan rate of 50° F./min (10° C./min). With particular respect to FIG. 9, the change of percent crystallinity (χ_{c}) for a degradable material was plotted as a function of time. A melting enthalpy of PBT at 145 J/mole was used to calculate χ_{c}.

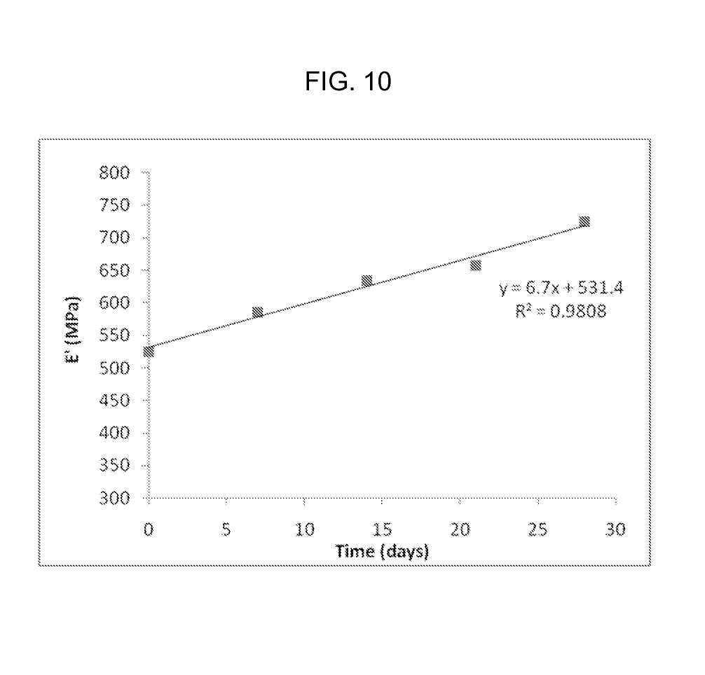

The change of storage modulus for the degradable material Hytrel® 7246 was also measured as degradation proceeded in water at 208° F. (98° C.). The storage modulus was measured using dynamic modeling analysis (DMA) at 0.1% constant strain at room temperature. With particular respect to FIG. 10, storage modulus (E′) for the material is plotted as a function of degradation time. Prior to analysis, water in the samples was removed by drying under vacuum for seven to fourteen days.

In another example, the elastic modulus for a degradable material was measured as the material degraded over time. Degradation may occur by a number of various routes such as oxidation, UV, or heat and may be accompanied by a decrease of elongation to failure. The elastic modulus can either increase or decrease depending on the predominant degradation mechanism, which may include, for example, post-crosslinking or chain scission. However, degradable materials in accordance with the present disclosure may have a structure that contains crystalline hard segments and amorphous soft segments, which experiences a modulus increase as the material degrades. The modulus of the TPE can be estimated using the parallel combination rule of mixtures:

E=E_{c}χ_{c}+Eₐ(1−χ_{c})

where E_{c} is the modulus of the crystalline (hard) segment and Eₐ is the modulus of the amorphous (soft) segment.

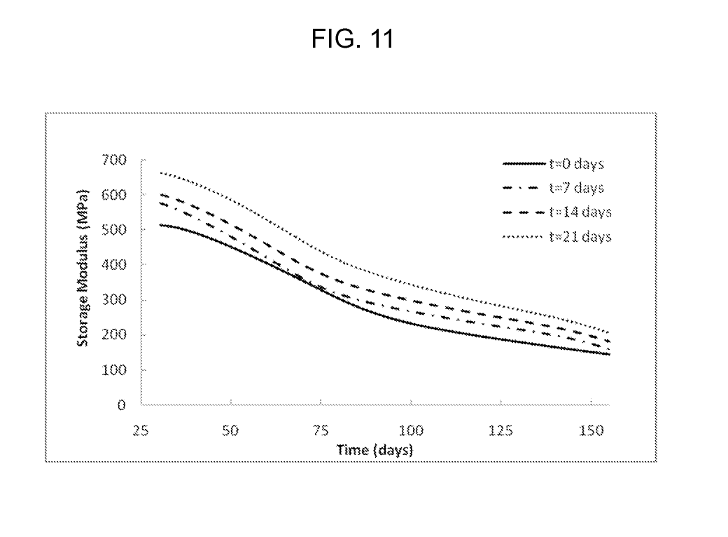

With particular respect to FIG. 11, the storage modulus for the degradable material Hytrel® 7246 is plotted as a function of time. In particular, the change of storage modulus of a degradable material is shown in the temperature range of 77° F. (25° C.) to 302° F. (150° C.) during 21 days of degradation at 208° F. (98° C.). The modulus was measured by DMA at the constant strain of 0.1%. Water diffusion and hydrolytic degradation were much faster in the amorphous phase than in the crystalline phase. While not bound by a particular theory, it is hypothesized that degradation resulted in shorter chains in the amorphous phase, allowing a rearrangement that increased the size of the crystalline phase domains. Because of this degradation and rearrangement of the crystalline phase over a broad range of temperatures, the T_{g} and Tₘ of the material actually increased during degradation as shown in FIG. 11. However, while the modulus of each sample decreased with increasing temperature, the tensile strength decreased as the degradation proceeded.

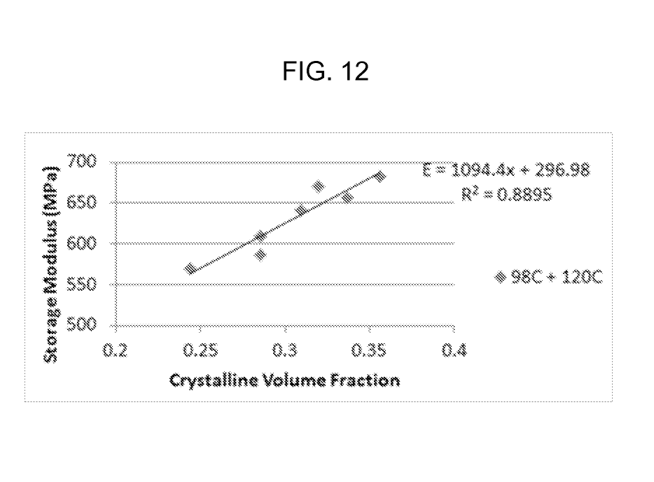

With particular respect to FIG. 12, the storage modulus for a degradable material is plotted as a function of the crystalline volume fraction, which demonstrates an increase in the storage modulus of a degradable material as the crystalline volume fraction of the material increases. The storage modulus as a function of percent crystallinity for the Hytrel® 7246 samples degraded in water at 208° F. (98° C.) and 248° F. (120° C.) shows a linear relationship, implying that the modulus of this semi-crystalline degradable material correlates to the volume fraction of the crystalline phase regardless of their thermal history.

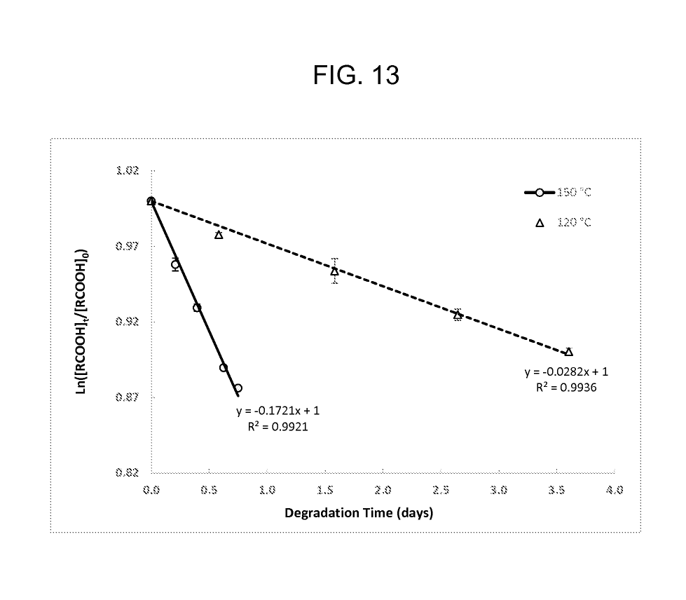

In another example, dried samples of Hytrel® were titrated to track degradation by measuring the concentration of acid end groups generated through ester hydrolysis. As observed by tracking the concentration of acid end groups generated, degradation of the material occurs at a constant rate. With respect to FIG. 13, the result of acid end group titration appears to follow pseudo first order reaction kinetics with apparent rate constants of 3.22E-7 s⁻¹ and 1.98E-6 s⁻¹ at 248° F. (120° C.) and 302° F. (150° C.) respectively.

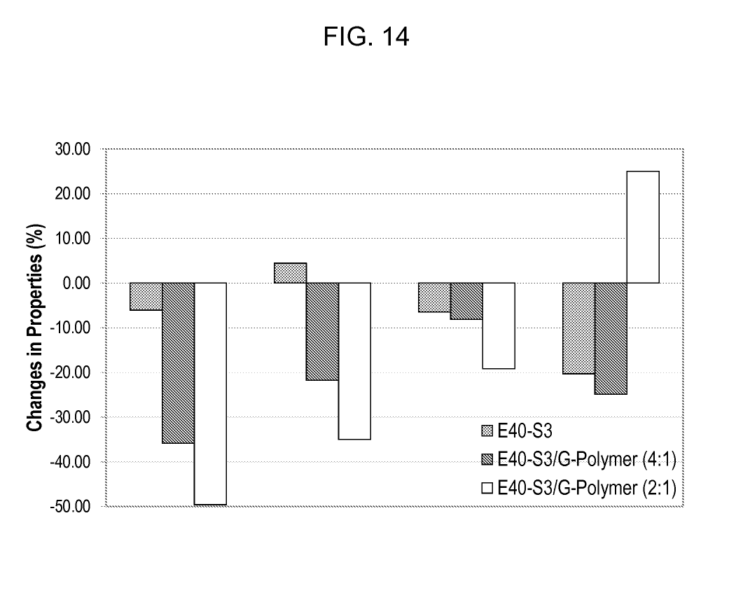

In another example, thermoplastic polyamide elastomer Vestamid® E40-S3 (Evonik) and two compounds with Vestamid® E40-S3 as the matrix and an amorpohous vinyl alcohol-based resin G-Polymer 1070 (commercially available from NIPPON GOHSEI) as the additive were exposed to water at 250° F. (121° C.). The weight ratios of E40-S3/G-Polymer in the two compounds are 4:1 and 2:1 respectively. As shown in FIG. 14, after aging in water for 2 hours at 250° F. (121° C.), all three samples have shown measurable decreases in modulus, tensile strength and elongation at break, with exceptions seen in the modulus change at 50% strain for E40-S3 and elongation at break of E40-S3/G-Polymer (2:1).

From a qualitative inspection of samples of E40-S3/G-Polymer 4:1 and E40-S3/G-Polymer 2:1 after aging in water at 250° F. (121° C.) for 96 hours it was noted that the samples began to exhibit physical defects. For the E40-S3/G-Polymer 4:1 sample, bubbles and cracks developed at the sample edges, while the sample of E40-S3/G-Polymer 2:1 showed penetrating cracks. Both samples broke into pieces while handling, before quantitative property measurements could be performed. In another example, samples of each of the polymers completely degraded after aging in water for 96 hours at 325° F. (163° C.) and 350° F. (177° C.), creating a cloudy dispersion with some sedimentation.

Although only a few examples have been described in detail above, those skilled in the art will readily appreciate that many modifications are possible in the examples without materially departing from this subject disclosure. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112 (f) for any limitations of any of the claims herein, except for those in which the claim expressly uses the words ‘means for’ together with an associated function.

What is claimed:

1. A method comprising:
emplacing a degradable material into a wellbore, wherein the degradable material comprises a thermoplastic elastomer;
contacting the degradable material with an aqueous fluid downhole; and
allowing the degradable material to at least partially degrade.

2. The method of claim 1, wherein the thermoplastic elastomer is one or more of a polyesteramide, a polyetherester, a polyetheresteramide, polycarbonateesteramides, polyether-block-amides, polyphthalamide, copolyester elastomers, and thermoplastic polyurethane elastomers.

3. The method of claim 1, wherein the temperature of the wellbore is in the range of 100° F. to 400° F.

4. The method of claim 1, wherein the degradable material further comprises a compound that reacts to produce an acid or a base.

5. The method of claim 1, wherein the aqueous fluid comprises an acid or a base.

6. The method of claim 1, wherein the degradable material is swellable.

7. The method of claim 6, wherein the degradable material further comprises water absorbing fillers selected from one or more of NaCl, ZnCl₂, CaCl₂, MgCl₂, Na₂CO₃, K₂CO₃, KH₂PO₄, K₂HPO₄, K₃PO₄, sulfonate salts, bentonite, halloysite, kaolinite, montmorillonite, polyacrylamide, polyvinyl alcohol, poly(ethylene-co-vinyl alcohol), modified ethylene vinyl alcohol, amorphous vinyl alcohol resin, polyacrylic acid, poly(methacrylic acid), poly(acrylic acid-co-acrylamide, poly(acrylic acid)-graft-poly(ethylene oxide), poly(2-hyroxyethylmethacrylate), and starch-grafted polymers.

8. The method of claim 1, wherein the degradable material further comprises a filler selected from at least one of carbon black, silica, calcium carbonate, clay, talc, dolomite, mica, montmorillonite, barite, calcium sulfate, wollastonite, phyllosilicates, and particulate polylactic acid.

9. The method of claim 1, wherein the degradable material further comprises a degradable polymer selected from one or more of aliphatic polyesters, poly(lactic acid), poly(ε-caprolactone), poly(glycolic acid), poly(lactic-co-glycolic acid), poly(hydroxyl ester ether), poly(hydroxybutyrate), poly(anhydride), polycarbonate, poly(amino acid), poly(ethylene oxide), poly(phosphazene), polyether ester, polyester amide, polyamides, sulfonated polyesters, poly(ethylene adipate), polyhydroxyalkanoate, poly(ethylene terephtalate), poly(butylene terephthalate), poly(trimethylene terephthalate), and poly(ethylene naphthalate).

10. A method comprising:
emplacing into a wellbore a tool containing a sealing element thereon, wherein the sealing element comprises a degradable material;
engaging the sealing element with a downhole surface to establish a seal;
contacting the sealing element with an aqueous fluid; and
allowing the sealing element to at least partially degrade, thereby disrupting the established seal.

11. The method of claim 10, wherein the aqueous fluid comprises an acid or a base.

12. The method of claim 10, wherein the sealing element is a swellable element, and wherein contacting the sealing element with an aqueous fluid causes the sealing element to expand.

13. The method of claim 10, wherein the degradable material is one or more of a polyesteramide, a polyetherester, a polyetheresteramide, polycarbonateesteramides, polyether-block-amides, polyphthalamide, copolyester elastomers, and thermoplastic polyurethane elastomers.

14. A downhole tool comprising at least one element constructed from a degradable material, wherein the degradable material comprises a thermoplastic elastomer.

15. The downhole tool of claim 14, wherein the downhole tool is selected from a group consisting of pivot darts, packers, frac plugs, frac balls and bridge plugs.

16. The downhole tool of claim 14, wherein hydraulic pressure is used to set the downhole tool to form a seal.

17. The downhole tool of claim 14, wherein the thermoplastic elastomer is one or more of a polyesteramide, a polyetherester, a polyetheresteramide, polycarbonateesteramides, polyether-block-amides, polyphthalamide, copolyester elastomers, and thermoplastic polyurethane elastomers.

18. The downhole tool of claim 14, wherein the element is swellable.

19. The downhole tool of claim 18, wherein the element further comprises a water absorbing filler selected from one or more of NaCl, ZnCl₂, CaCl₂, MgCl₂, Na₂CO₃, K₂CO₃, KH₂PO₄, K₂HPO₄, K₃PO₄, sulfonate salts, bentonite, halloysite, kaolinite, montmorillonite, polyacrylamide, polyvinyl alcohol, poly(ethylene-co-vinyl alcohol), modified ethylene vinyl alcohol, amorphous vinyl alcohol resin, polyacrylic acid, poly(methacrylic acid), poly(acrylic acid-co-acrylamide, poly(acrylic acid)-graft-poly(ethylene oxide), poly(2-hyroxyethylmethacrylate), and starch-grafted polymers.

20. The downhole tool of claim 14, wherein the degradable material further comprises a filler selected from at least one of carbon black, silica, calcium carbonate, clay, talc, dolomite, mica, montmorillonite, barite, calcium sulfate, wollastonite, phyllosilicates, and particulate polylactic acid.
